(19) United States
(12) Patent Application Publication
(10) Pub. No.: US 2025/0172249 A1
(43) Pub. Date: May 29, 2025

(54) REFUELING STATION AND METHOD TO REFUEL A CRAWLER VEHICLE WITH HYDROGEN

(71) Applicant: PRINOTH S.P.A., Vipiteno (IT)

(72) Inventors: Martin Kirchmair, Pfons (AT); Jamie Thom, Mieders (AT); Roberto Pegoraro, Vipiteno (IT); Alberto Paoletti, Vipiteno (IT)

(21) Appl. No.: 18/955,112

(22) Filed: Nov. 21, 2024

(30) Foreign Application Priority Data
Nov. 29, 2023 (IT) 102023000025428

(51) Int. Cl. F17C 5/00

(52) U.S. Cl. CPC F17C 5/007; F17C 2205/0111; F17C 2205/0364; F17C 2205/037; F17C 2221/012; F17C 2227/0157; F17C 2227/0302; F17C 2265/065; F17C 2270/0168

(57) ABSTRACT

A refueling station to refuel a crawler vehicle with hydrogen at a work site is configured to be transported to the work site and has a compressor unit configured to receive, as an input, hydrogen from a hydrogen source and/or from a hydrogen distribution network and to compress the received hydrogen; and an injection nozzle, which is connected to the compressor unit and is configured to be coupled to a hydrogen accumulator of the crawler vehicle so as to dispense the compressed hydrogen into the hydrogen accumulator.

### PRIORITY CLAIM

This application claims the benefit of and priority to Italian Patent Application No. 102023000025428, filed on Nov. 29, 2023, the entire contents of which is incorporated by reference herein.

### TECHNICAL FIELD

The present disclosure relates to a refueling station and method to refuel a crawler vehicle with hydrogen at a work site.

### BACKGROUND

The increasing attention towards global pollution reduction has led to the development of crawler vehicles equipped with alternative powering systems supplied with renewable energy sources, such as, for example, hydrogen fuel cells.

Certain hydrogen-powered crawler vehicles comprise a hydrogen accumulator provided with a plurality of hydrogen-containing power tanks, a fuel cell configured to generate electrical energy from hydrogen and an electric motor powered by the electrical energy generated by the fuel cell.

When the hydrogen contained in the supply tanks is almost exhausted, it is necessary to refuel the crawler vehicle.

Generally, refueling is carried out by connecting the crawler vehicle to a refueling system, which is installed at the work site and includes a high-pressure storage tank, typically between 900 bar and 1000 bar, so as to allow the gas in the storage tank to flow into the supply tanks of the crawler vehicle, which have an inner pressure of less than 700 bar. However, since the storage tank contains high-pressure hydrogen, the refueling procedure involves relative risks and currently known refueling systems are relatively expensive and large. As a result, the number of the refueling systems in the entire work site is relatively limited and sometimes it is not sufficient to cover the entire work site of the crawler vehicle.

### SUMMARY

In certain embodiments, an object of the disclosure is to provide a refueling station to refuel a crawler vehicle with hydrogen, which reduces certain of the drawbacks of certain of the prior art.

According to certain embodiments of the disclosure, there is provided a refueling station to refuel a crawler vehicle with hydrogen at a work site, the refueling station being configured to be transported to the work site and including a compressor unit configured to receive hydrogen, as an input, from a hydrogen source and/or from a hydrogen distribution network and to compress the received hydrogen; and an injection nozzle, which is connected to the compressor unit and is configured to be coupled to a hydrogen accumulator of the crawler vehicle to deliver the compressed hydrogen into the hydrogen accumulator.

Accordingly, it is possible to refuel the crawler vehicle with hydrogen directly at the work site, without the need to install a relatively expensive and large refueling system for an intermediate storage of high-pressure hydrogen. In practice, the absence of an intermediate storage tank makes it possible to increase the relative safety of the refueling procedure of the crawler vehicle.

In addition, it is possible to create a relatively light and small refueling station, which enables the refueling station to be transported on-road and off-road. In this way, a plurality of refueling stations can be placed in given areas of the work site to cover the entire work site of the crawler vehicle. Depending on the particular needs, it is possible to relatively easily move the refueling stations within the work site to adjust, for example, the distance between the refueling stations.

In particular, the refueling station comprises an outer casing arranged around the compressor unit so as to protect and isolate the compressor unit from the external environment.

In particular, the outer casing extends along a first direction for a first length comprised between 1.5 meters and 2.5 meters, along a second direction substantially perpendicular to the first direction for a second length comprised between 3 meters and 4 meters, and along a third direction substantially perpendicular to the first direction and to the second direction for a third length comprised between 1.5 meters and 2.5 meters. In this way, the refueling station is reduced in size and, as a consequence, can be relatively easily transported within the work site and/or from one work site to another.

In particular, the refueling station comprises a manifold configured to fluidically connect the compressor unit to the injection nozzle. In more detail, the manifold comprises a flexible connection pipe. In this way, it is possible to supply hydrogen under pressure from the compressor unit to the injection nozzle.

In particular, the refueling station comprises an electrical connector configured to be coupled to a power supply module. In this way, it is possible to supply electrical power to the refueling station to supply, in particular, the compressor unit.

In certain embodiments, a further object of the disclosure is to provide a refueling method to refuel a crawler vehicle with hydrogen, which reduces certain of the drawbacks of certain of the prior art. According to certain embodiments of the disclosure, there is provided a refueling method to refuel a crawler vehicle with hydrogen at a work site, the refueling method including transporting a hydrogen refueling station comprising a compressor unit and an injection nozzle to the work site, injecting hydrogen into the compressor unit from a hydrogen source and/or from a hydrogen distribution network, compressing the received hydrogen by the compressor unit, coupling the injection nozzle to a hydrogen accumulator of the crawler vehicle, and delivering the compressed hydrogen into said hydrogen accumulator by the injection nozzle. It should be appreciated that based on this method, it is possible to refuel the crawler vehicle with hydrogen in a relatively safe and simple manner, without the need to install a relatively expensive and large refueling system for an intermediate storage of high-pressure hydrogen.

According to a further embodiment of the disclosure, a refueling method includes placing a first hydrogen-powered crawler vehicle in proximity to a second hydrogen-powered crawler vehicle, connecting a first hydrogen accumulator of the first crawler vehicle to a second hydrogen accumulator of the second crawler vehicle by a connection pipe, and feeding a flow of hydrogen from the first hydrogen accumulator to the second hydrogen accumulator through said connection pipe. In this way, it is possible to refuel a crawler vehicle with hydrogen even when the crawler vehicle is located at a relative distance from one of the refueling stations.

### BRIEF DESCRIPTION OF THE DRAWINGS

Further features and advantages of the disclosure will be best understood upon perusal of the following description of a non-limiting embodiment thereof, with reference to the accompanying Figures, wherein:

FIG. 1 is a plan view, with parts removed for greater clarity and schematic parts, of a crawler vehicle and of a refueling system according to an embodiment of the disclosure;

FIG. 2 is a perspective view, with parts removed for greater clarity, of a refueling station of the refueling system of FIG. 1;

FIG. 3 is a side view, with parts removed for greater clarity, of a transport vehicle and of a hydrogen source of the refueling system of FIG. 1 carried by the transport vehicle; and

FIG. 4 is a plan view, with parts removed for greater clarity and schematic parts, of a first and a second crawler vehicle during a step of a refueling method carried out according to an embodiment of the disclosure.

### DETAILED DESCRIPTION

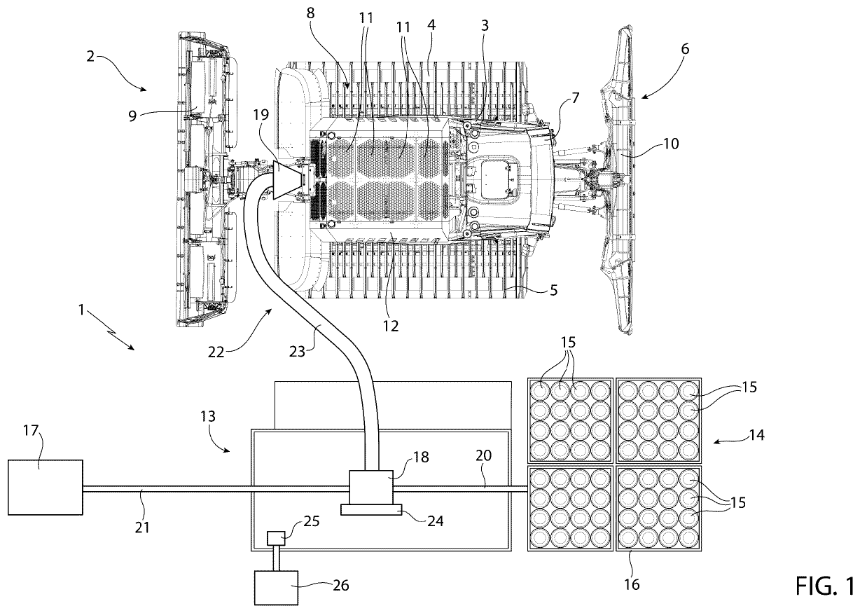

With reference to FIG. 1, number 1 indicates, as a whole, a refueling system to refuel a crawler vehicle 2 with hydrogen at a work site.

In the case described and shown herein (which does not limit the disclosure), the crawler vehicle 2 is used for the preparation of ski runs. In particular, the crawler vehicle 2 is a snow groomer.

In more detail, the crawler vehicle 2 is used for the preparation of ski runs for Alpine skiing and/or ski runs for cross-country skiing and/or ramps for ski jumping and/or half-pipes and/or snow-parks.

It should be pointed out that, according to a further embodiment, the crawler vehicle 2 can be used in agricultural operations, such as for example the harvesting and/or the handling of agricultural products and/or the ensilage of fodder and/or the harvesting and/or the handling of bagasse. According to this configuration, the crawler vehicle 2 can comprise a mulcher, such as a mulcher located on the front side of the crawler vehicle 2 and can be used to mulch plants.

According to a further embodiment, the crawler vehicle 2 can be used to clean beaches and/or to process sandy areas.

The crawler vehicle 2 is powered by hydrogen and comprises a frame 3; a track 4; a track 5; a set of tools 6 connected to the frame 3; a cabin 7 mounted on the frame 3; and a hydrogen accumulator 8.

In the non-limiting embodiment of the disclosure described and shown herein, the set of tools 6 comprises a tiller 9, which is connected to the frame 3 in a movable manner, and a shovel 10, which is connected to the frame 3 in a movable manner.

The hydrogen accumulator 8 comprises a plurality of supply tanks 11 configured to contain hydrogen and a housing structure 12 configured to house the supply tanks 11. In particular, the hydrogen accumulator 8 is located behind the cabin 7 relative to a travel direction of the crawler vehicle 2.

According to an embodiment, the crawler vehicle 2 further comprises a fuel cell (not shown in the drawings), which is configured to receive hydrogen from the hydrogen accumulator 8 and to generate electrical energy from the received hydrogen; and an electric drive system (not shown in the drawings), which is powered by the electrical energy generated by the fuel cell and is configured to transmit power to the tracks 4, 5 and the set of tools 6.

According to an alternative embodiment (not shown in the drawings), the crawler vehicle 2 comprises a hydrogen-powered internal combustion engine. In particular, the internal combustion engine is configured to receive hydrogen from the hydrogen accumulator 8 and to transmit power to the tracks 4, 5 and to the set of tools 6.

The refueling system 1 comprises a refueling station 13 to refuel the crawler vehicle 2 with hydrogen at the work site.

In particular and without limiting the wide range of possible applications of the disclosure, the work site can be a ski area or a ski run or an agricultural land or a beach or a stretch of sand.

In addition, the refueling system 1 comprises a hydrogen source 14, which is connected to the refueling station 13 so as to feed hydrogen to the refueling station 13 and comprises at least one hydrogen tank 15. The hydrogen source 14 comprises a containment frame 16 configured to contain a plurality of hydrogen tanks 15, such as, for example, hydrogen cylinders.

In addition or alternatively, the refueling system 1 comprises a hydrogen distribution network 17 connected to the refueling station 13 so as to feed hydrogen to the refueling station 13.

The refueling station 13 is configured to be transported to the work site and comprises a compressor unit 18 configured to receive, as an input, hydrogen from the hydrogen source 14 and/or from the hydrogen distribution network 17 and to compress the received hydrogen; and an injection nozzle 19, which is connected to the compressor unit 18 and is configured to be coupled to the hydrogen accumulator 8 of the crawler vehicle 2 to dispense the compressed hydrogen into the hydrogen accumulator 8.

In more detail, the refueling station 13 is configured to be coupled to a front portion of the frame 3 of the crawler vehicle 2 and/or to the shovel 10 and, in certain instances, comprises hooking devices (not shown in the drawings), configured to enable the refueling station 13 to be lifted by a crane.

In particular, the refueling system 1 comprises a connection pipe 20 to fluidically connect the hydrogen source 14 to the compressor unit 18.

Alternatively or in addition, the refueling system 1 comprises a connection pipe 21 to fluidically connect the hydrogen distribution network 17 to the compressor unit 18.

In the specific case described and shown herein, the refueling station 13 comprises a manifold 22 configured to fluidically connect the compressor unit 18 to the injection nozzle 19. In particular, the manifold 22 comprises a flexible connection pipe 23.

Furthermore, the refueling station 13 comprises a heating unit 24 configured to heat the compressor unit 18. In particular, the heating unit 24 comprises a heat exchanger and/or an electrical resistance.

According to an embodiment of the present disclosure, the refueling station 13 comprises an electrical connector 25 configured to be coupled to an external power supply module 26. In particular, the electrical connector 25 electrically connects the power supply module 26 to the compressor unit 18, so as to electrically power the compressor unit 18.

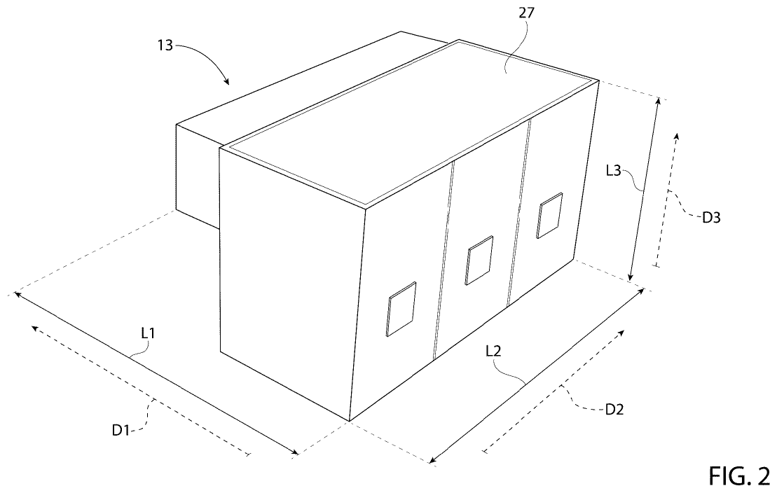

With reference to FIG. 2, the refueling station 13 comprises an outer casing 27 arranged around the compressor unit 18. In other words, the compressor assembly 18 is enclosed within the outer casing 27.

In the specific case described and shown herein, the outer casing 27 has the shape of a parallelepiped.

The outer casing 27 extends along a direction D1 for a first length L1 comprised between 1.5 meters and 2.5 meters, along a direction D2 substantially perpendicular to the direction D1 for a second length L2 comprised between 3 meters and 4 meters, and along a direction D3 substantially perpendicular to the directions D1 and D2 for a third length L3 comprised between 1.5 meters and 2.5 meters. In other words, the directions D1, D2 and D3 are substantially perpendicular to one another.

In particular, the outer casing 27 is made of a thermally insulating material.

In use and with reference to FIG. 1, the refueling station 13 is transported to the work site and is placed in a certain refueling zone of the work site.

In more detail, the transport of the refueling station 13 is carried out by a transport vehicle, such as, for example, a crawler vehicle or a truck. According to certain embodiments, a crane loads and unloads the refueling station 13 onto/from the transport vehicle.

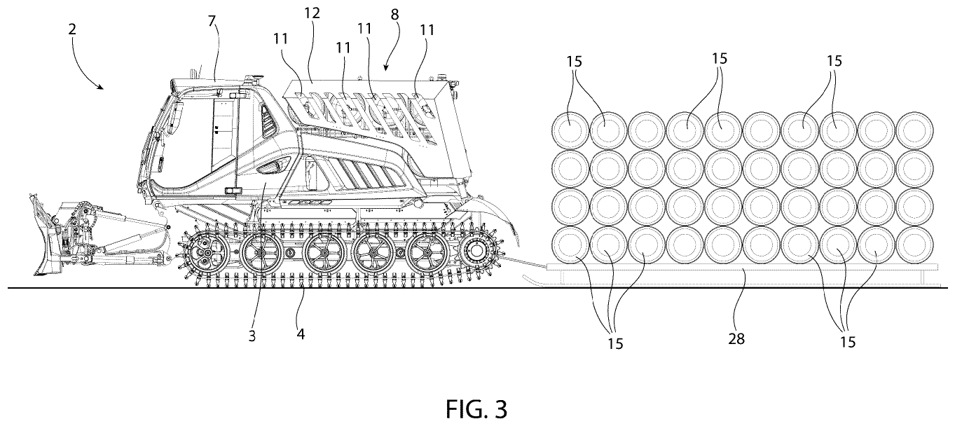

With reference to FIG. 3, the hydrogen tanks 15 of the hydrogen source 14 are transported to the refueling station 13 by a transport vehicle, such as, for example, the crawler vehicle 2.

In the specific case described and shown herein (which does not limit the disclosure), the hydrogen tanks 15 are loaded onto a slide 28 towed by the crawler vehicle 2, which transports the hydrogen tanks 15 to the refueling zone where the refueling station 13 is located.

With reference to FIG. 1, the crawler vehicle 2 to be refueled is placed in the vicinity of the refueling station 13 and the injection nozzle 19 is coupled to the hydrogen accumulator 8 of the crawler vehicle 2.

The first part of the refueling takes place by exploiting the pressure difference between the hydrogen contained in the hydrogen tanks 15 of the hydrogen source 14 and the hydrogen contained in the hydrogen accumulator 8. At this stage, a hydrogen flow is naturally fed from the hydrogen source 14 to the hydrogen accumulator 8 through the manifold 22 and the injection nozzle 19.

When the pressure difference between the hydrogen contained in the hydrogen tanks 15 of the hydrogen source 14 and the hydrogen contained in the hydrogen accumulator 8 decreases and is no longer sufficient to feed a flow of hydrogen from the hydrogen source 14 to the hydrogen accumulator 8, the compressor unit 18 of the refueling station 13 is connected to the hydrogen source 14 through the connection pipe 20 and/or to the hydrogen distribution network 17 through the connection pipe 21.

Subsequently, hydrogen is fed by the hydrogen source 14 and/or by the hydrogen distribution network 17 to the compressor unit 18. The compressor unit 18 compresses the incoming hydrogen and conveys the compressed hydrogen to the injection nozzle 19, which delivers the compressed hydrogen to the hydrogen accumulator 8.

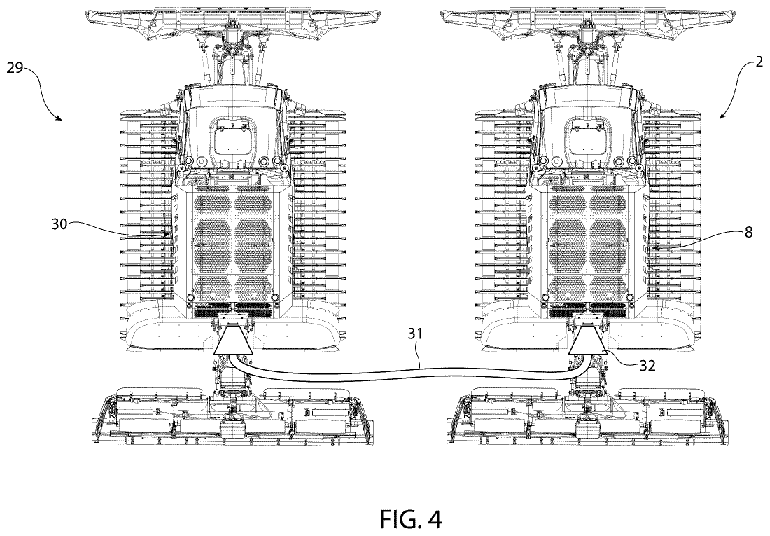

With reference to FIG. 4, when the hydrogen accumulator 8 of the crawler vehicle 2 is almost out of hydrogen and the crawler vehicle 2 is relatively far from one of the refueling stations 13, a further crawler vehicle 29 comprising a hydrogen accumulator 30 reaches the crawler vehicle 2 and stops beside the crawler vehicle 2. In particular, the hydrogen accumulator 30 contains a first quantity of hydrogen that is greater than a second quantity of hydrogen contained in the hydrogen accumulator 8.

At this point, the hydrogen accumulator 30 of the crawler vehicle 29 is connected to the hydrogen accumulator 8 of the crawler vehicle 2 through a connection pipe 31 provided with a nozzle 32 at one end and a flow of hydrogen is fed from the hydrogen accumulator 30 to the hydrogen accumulator 8 through the connection pipe 31 so as to supply the crawler vehicle 2 with hydrogen.

In particular, the hydrogen feeding flow through the connection pipe 31 is regulated by a valve assembly (not shown in the drawings), as a function of the pressure and/or temperature of the hydrogen contained in the hydrogen accumulators 8 and 30.

Finally, it is evident that variations can be made to the present disclosure with respect to the embodiments described with reference to the accompanying figures without however departing from the scope of protection of the following claims. That is, the present disclosure also covers embodiments that are not described in the detailed description above as well as equivalent embodiments that are part of the scope of protection set forth in the claims. Accordingly, various changes and modifications to the presently disclosed embodiments will be apparent to those skilled in the art.

The invention claimed is:

1. A refueling station configured to be transported to a work site, the refueling station comprising:
a compressor unit configured to:
receive hydrogen in input from at least one of a hydrogen source and a hydrogen distribution network, and
compress the received hydrogen; and
an injection nozzle connected to the compressor unit and configured to be coupled to a hydrogen accumulator of a crawler vehicle to deliver the compressed hydrogen into the hydrogen accumulator of the crawler vehicle.

2. The refueling station of claim 1, further comprising an outer casing arranged around the compressor unit.

3. The refueling station of claim 2, wherein the outer casing extends along a first direction for a first length of between 1.5 meters and 2.5 meters, along a second direction substantially perpendicular to the first direction for a second length of between 3 meters and 4 meters, and along a third direction substantially perpendicular to the first direction and to the second direction for a third length of between 1.5 meters and 2.5 meters.

4. The refueling station of claim 1, further comprising a manifold configured to fluidically connect the compressor unit to the injection nozzle.

5. The refueling station of claim 4, wherein the manifold comprises a flexible connection pipe.

6. The refueling station of claim 1, further comprising a heating unit configured to heat the compressor unit.

7. The refueling station of claim 1, further comprising an electrical connector configured to be coupled to a power supply module.

8. A refueling system to refuel a crawler vehicle with hydrogen at a work site, the refueling system comprising:
a hydrogen source comprising at least one hydrogen tank; and
a refueling station comprising:
a compressor unit configured to:
receive hydrogen from the hydrogen source, and
compress the received hydrogen; and
an injection nozzle connected to the compressor unit and configured to be coupled to a hydrogen accumulator of the crawler vehicle to deliver the compressed hydrogen into the hydrogen accumulator of the crawler vehicle.

9. The refueling system of claim 8, wherein the hydrogen source comprises a containment frame configured to contain a plurality of hydrogen tanks.

10. A method of refueling a crawler vehicle with hydrogen at a work site, the method comprising:
transporting a hydrogen refueling station comprising a compressor unit and an injection nozzle to the work site;
injecting hydrogen into the compressor unit from at least one of a hydrogen source and a hydrogen distribution network;
compressing the hydrogen received by the compressor unit;
coupling the injection nozzle to a hydrogen accumulator of the crawler vehicle; and
delivering the compressed hydrogen into the hydrogen accumulator of the crawler vehicle by the injection nozzle.

11. The method of claim 10, further comprising moving the refueling station from the work site to another work site by at least one of a transport vehicle and a crane.

12. The method of claim 10, further comprising connecting the compressor unit to the at least one of the hydrogen source and the hydrogen distribution network.

13. The method of claim 10, further comprising coupling the hydrogen source comprising a plurality of hydrogen tanks to a transport vehicle, and transporting the hydrogen source at the refueling station by the transport vehicle.

14. A method to refuel a crawler vehicle with hydrogen at a work site, the method comprising:
placing a first hydrogen-fueled crawler vehicle in proximity to a second hydrogen-fueled crawler vehicle;
connecting, by a connection pipe, a first hydrogen accumulator of the first crawler vehicle to a second hydrogen accumulator of the second crawler vehicle; and
feeding, through the connection pipe, a flow of hydrogen from the first hydrogen accumulator to the second hydrogen accumulator.

15. The method of claim 14, wherein the first hydrogen accumulator contains a first amount of hydrogen and the second hydrogen accumulator contains a second amount of hydrogen less than the first amount of hydrogen.

16. The method of claim 14, further comprising controlling the flow through the connection pipe according to at least one of a pressure of the hydrogen contained in the first hydrogen accumulator, a temperature of the hydrogen contained in the first hydrogen accumulator, a pressure of the hydrogen contained in the second hydrogen accumulator, and a temperature of the hydrogen contained in the second hydrogen accumulator.
